(19) United States
(12) Patent Application Publication
(10) Pub. No.: US 2018/0117884 A1
(43) Pub. Date: May 3, 2018

(54) METHOD FOR MAKING LIGHT AND STIFF PANELS AND STRUCTURES USING NATURAL FIBER COMPOSITES

(71) Applicant: Joseph E. Luttwak, San Francisco, CA (US)

(72) Inventor: Joseph E. Luttwak, San Francisco, CA (US)

(21) Appl. No.: 15/788,767

(22) Filed: Oct. 19, 2017

Related U.S. Application Data
(63) Continuation-in-part of application No. 14/546,518, filed on Nov. 18, 2014, now Pat. No. 9,818,380.
(60) Provisional application No. 61/905,752, filed on Nov. 18, 2013.
(60) Provisional application No. 62/446,809, filed on Jan. 16, 2017.

(51) Int. Cl. B32B 21/14; B32B 5/18; B32B 3/12

(52) U.S. Cl. CPC B32B 21/14; G10D 1/08; B32B 3/12; B32B 5/18

(57) ABSTRACT

Methods for making light and stiff panels and structures using natural fiber composites. Bio-based industrial fiber such as flax, cellulose, hemp, bamboo, and jute combined with a core material such as foam, aramid honeycomb, carbon fiber or balsa wood, and a resin, serves as a replacement to traditional tone wood. In some embodiments, the bio-based composite has no core material but simply layers of fabric with resin. Hence, in its various forms, bio-composite can effectively replace natural wood currently used.

### CROSS REFERENCE TO RELATED APPLICATIONS

This non-provisional application is a continuation-in-part and claims the benefit of U.S. application Ser. No. 14/546,518, filed Nov. 18, 2014, recently allowed, which claims the benefit of U.S. provisional application No. 61/905,752, filed Nov. 18, 2013, expired, both of the same title, which applications are incorporated herein in their entirety by this reference.

Also, this non-provisional application claims the benefit of U.S. provisional application No. 62/446,809, filed Jan. 16, 2017, pending, of the same title, which application is incorporated herein in its entirety by this reference.

### BACKGROUND

The present invention relates to string instruments. Stringed instruments traditionally have been constructed of wood, but also have been fabricated from plastics, molded composite materials, and combinations of such materials. As shown in FIG. 1, a conventional stringed instrument typically includes a body 10, a neck 12, a head 14 (sometimes called a “headstock”), a soundboard 16, a fingerboard 18 (sometimes called a “fretboard”), strings 20, a bridge 22 and a sound hole 24. In acoustic stringed instruments the interior of body 10 is hollow, and forms a resonant cavity, often called a “sound chamber.” In acoustic stringed instruments, the vibration of strings 20 is transmitted through bridge 22 to the body via soundboard 16. In turn, the vibration of soundboard 16 vibrates air inside the sound chamber, and produces the sound that is projected from sound hole 24.

Acoustic string instruments are traditionally made of wood. As known to one skilled in the art, the material choice used to make soundboards are of particular import as this component accounts for the vast majority of the resonance and quality of sound produced. The back and sides, often tropical hardwoods such as Rosewood and mahogany and are known to impact the instrument sound as well. The wood commonly used for soundboards exhibit specific mechanical properties that result in tonal qualities desired by players and listeners.

Throughout history, certain species of wood have been known to possess good qualities for use as string instrument soundboards. The instrument's success has traditionally relied upon the skills of a luthier (string instrument maker) to utilize these preferred species and select plates that display superior resonating properties. In recent times, researchers have determined the attributes that impart these wood species and specific plates made thereof namely with high specific modulus and low internal friction in the grain direction produce the best soundboards [3]. Ono et al.

Further demonstrated that the stiffness in the cross-grain direction is also an important factor [3]. The shear modulus has been shown to govern the behavior in the high frequency range [1]. Thus all of these dynamic properties must be taken into consideration when developing an engineered material to replace wood.

Other important factors are the density, thickness and strength of the material. It is critical not to exceed the areal density of a typical spruce soundboard in order to maintain the radiation efficiency of the instrument. A spruce soundboard of about 2.5 mm thickness typically has an areal density ranging from approximately 1.1 to 1.5 kg/m

Old-growth soft woods such as spruce, cedar and to a significantly lesser degree cypress and redwood, are all sought after for soundboard use. After centuries of experimentation, these woods have become the ideal choice because of a few factors: high stiffness-to-weight (tensile modulus) along the grain, very low mass and density. This attributes together form a highly resonant sound-board which transforms string energy into sound most efficiently. The relatively low density imparts a certain lossy quality to the sound by absorbing higher frequencies. This is characterized as a ‘woody’ sound-an abstract concept which speaks to the utility of this invention.

These aforementioned values were used as design guidelines to develop suitable ply sequences for the bio-composite sandwich panel. The material must also be strong enough to withstand the tension of the strings. Spruce has a bending strength ranging from approximately 80-130 MPa for 100 mm by 20 mm by 3 mm specimens.

The disadvantages of producing sound boards with these soft woods include sensitivity to humidity changes, fragility, scarcity, quality inconsistency, and public concern over diminishing resources from ever shrinking old-growth forests (see Sitka spruce).

In the last few decades, composites have emerged as a viable alternative material and it is clear why. An acoustic guitar that goes from a temperature and humidity controlled environment to a dry and hot climate typical of the American Southwest is likely to have the top crack as a result of the humidity delta. Composites such as epoxy/carbon fiber laminates in contrast are humidity insensitive.

From a structural perspective, wood instruments are fragile. Sound boards in particular are delicate because of the use of a thin plank of ¼″ or thinner soft wood which is easy cracked particularly along the grain. In the case of acoustic guitars, a complicated sub-assembly called bracing is adhered to the bottom surface of the top for structural support in part to overcome these shortcomings.

Another problem with wood is the high quality old growth wood used to make the prized examples is being increasingly scarce and Federally regulated under the Endangered Species Act (CITES). Taylor Guitars (San Diego, Calif.) for instance has acquired the majority of the world's available and legal ebony. Old growth Sitka Spruce (Picea sitchensis), used by many manufacturers of high quality acoustic instruments from guitars to pianos for soundboards, is a rapidly depleting and found only in Alaska's Tongass National Forest. These trees live to 700 years and beyond, making them very difficult to replenish. Renewable alternative to replace such trees are becoming increasingly necessary accordingly the large manufacture of acoustic instruments, Martin, has turned to Phenolic composite material as a reliable albeit sonically inferior alternative for their entry level instruments. This illustrated by Martin's use of Sitka Spruce for their more expensive instruments.

As a result of these durability issues, a few companies have introduced composite instruments made of humidity insensitive material such as carbon fiber and epoxy. This manner of construction has a number of design advantages including enabling one-piece construction and bi-directional stiff tops. These aforementioned are of particular import as they also add to the durability and environmental stability of the instrument. Specifically the bi-directional stiff top allows for a reduction in bracing which is the sub-structure typically bonded to the top of an inherently uni-directional wood top to give it additionally stiffness and strength particularly across the grain.

The problem with carbon fiber composites is tonal quality which is described as tinny and metallic as compared to tone woods such as spruce due to significantly less damping (see graph). Carbon fiber epoxy composites are high in density as compared to spruce which translates to less damping. This is a qualitative difference that results from the players and listeners accustomed to the specific sound of a wooden instrument. It is possible to reduce the density of a carbon composite by adding a core material, which is a sandwich structure, such as made with a honeycomb and a few layers of fabric on either side. The problem with that method is commercially available fabrics and core structures result in a composite that is too stiff. For an acoustic ukulele application for instance, this creates tone lacking in bass response and ‘warmth’.

Bio-based composites are lower in density as compared with carbon fiber. For instance flax linen, a preferred bio-based reinforcement fabric is typically around 1.45 g/cm³ while carbon fiber is typically 1.75 g/cm³. Bio-based reinforcements exhibit roughly 20% of the stiffness or tensile modulus of carbon fiber, but combined with a core are a viable solution to the problem of excessive stiffness plus density. By utilizing a core of approximately 1 mm-10 mm thick, depending on the application, the stiffness increases exponentially by the power of approximately three whenever the thickness doubles. This enables bio-based composites to achieve even greater stiffness-to-weight ratios than a solid carbon fiber laminate which does not employ sandwich construction and with lower mass and density. The desired stiffness can be attained by varying the thickness of the core and to a lesser degree the quantity of layers, type, and configuration of the fabrics. For a ukulele application for instance, a 0.5 mm thick 3×3k 190 gsm carbon fiber top can be replaced by 2×50 gsm uni-directional ‘flaxtape’ linen fabrics manufactured by Lineo of France and positioned at 0 degrees and 90 degrees along with a 1.7 mm Rohacell core made by Evonik of Germany. This bio-composite laminate has both increased tensile modulus and lower mass than the carbon fiber top described previously. In contrast, a sandwich structure made with unidirectional carbon fiber fabric of similar weight would have too great a stiffness to produce a pleasing acoustic tone. Further a conventional layup such as 3k plain weave carbon fiber, nomex, 3k plain weave carbon fiber is easily produced in a compression molding or autoclave process, but both too heavy and too stiff for a soundboard.

Dupont Kevlar also known as Aramid is another option with lower density than carbon fiber which has favorable wood-like characteristics. It does have its own host of problems well known to those familiar with the art including difficulty of adhesion to core layers, a ‘plastic’ aesthetic and difficultly to cut ‘cleanly’ and without fraying. Because it is a consistent material, it lacks the tonal complexity that comes from an organic, naturally derived material such as a bio-composite. Sandwich construction with a relatively thin laminate of fabric and resin is still much more consistent than wood enabling accurate control units for research and development purposes.

There have been many attempts to produce a string instrument using composite materials for both the sound board and body rather than the conventional wood. There are compelling reasons to find alternative materials for instrument construction. Wood guitars being sensitive to changes in humidity and temperature will crack, warp and change string height-often requiring repairs by a technician. Engineered composite material guitars such as Blackbird Guitars are highly resistant to humidity and temperature changes. With composites, greater stability is coupled with higher material consistency innate to fiber reinforced plastic. This is in contrast to natural wood, which can vary from individual tree to tree. Accordingly, manufacturing with composites offers higher consistency and consequently quality assurance, while at the same time tightening the tolerance of the final product. Another challenge faced by wood instrument manufacturers is obtaining instrument grade wood due to its increasing sacristy and regulated supply chain via CITES treaty restricted sourcing.

Wood instrument manufacturing and construction suffers from preponderance of issues, and yet unlike other sectors where wood has been replaced, it has doggedly remained the preferred material of choice. After several decades of research and development, instruments made with composite materials have yet to be seen as a credible alternative, and are considered to have both inferior sound quality and cosmetics. Generally, with few exceptions such as BlackBird Guitars of San Francisco, the current crop of synthetic offerings has not achieved the tonal quality found in premium wood instruments. This is made clear by low market acceptance, having penetrated less one percent of the market. Composite instruments have thus been relegated to a specialty within guitars rather than simply another widely accepted tone material alternative as with the various natural wood species. For instance, wood acoustic instruments are made from a variety of popular wood offerings, notably spruce, cedar, and mahogany. If composites had market acceptance within the music products space, they would be regarded on the same level as the aforementioned ‘tone’ woods.

Instead, with few exceptions, composite instruments are widely considered to produce inferior sound quality compared with similarly priced wood guitars. The quality of an instrument, including timbre, projection, dynamic range and responsive is largely driven by the soundboard component. As known to those familiar with the art, the soundboard assembly defines approximately 95% of the acoustic tone quality. Attempts at composite soundboards have not compared sonically with prized tone wood such as old growth spruce and cedar. These choice wood soundboards have the desirable specific stiffness at a narrow range of panel thickness and density. Most composite string instrument soundboards have inferior properties to natural wood soundboards. This results from the short-comings of composites materials currently used-mainly carbon fiber and to a lesser degree fiberglass.

For example, U.S. Pat. No. 6,107,552 Decker et al discloses the use of carbon fiber with nearly twice the density of the equivalent spruce. To reduce density, a sandwich panel is created with a few thin layers carbon fiber ‘skin’ and a core middle layer such as urethane foam or aramid honeycomb. Carbon fiber is greater mass than wood resulting in inhibited sound projection. Aramid honeycomb is lower density than urethane foam thereby reducing the overall mass of the sandwich panel though still shy of a wood soundboard.

Because of low surface area, it is difficult to adequately bond the composite layers to the honeycomb core. Previous attempts to make a sandwich panel soundboard have used adhesive film layers or additional liquid resin thereby increasing laminate density. The result remains inferior to spruce from a strength-to-weight ratio due to the added mass of the additional resin. In addition, Nomex cores are too low density area while the carbon fiber skins are too stiff. Carbon fiber's differential in material mechanical behavior compared with industry standard spruce, results in reduced bass response and volume as well as higher frequency note transmission typical of carbon fiber.

It is therefore apparent that an urgent need exists for light and stiff natural composite panels. These improved strength-to-weight material and structure improves the longevity, utility, weather-resistance, as well as quality consistency in production.

### SUMMARY

To achieve the foregoing and in accordance with the present invention, high strength to weight products are substantially made from bio-composite materials and methods for manufacturing thereof are provided. Such products are sturdy, highly humidity resistant, playable and without the many disadvantages of traditional wooden instruments.

Note that the various features of the present invention described above may be practiced alone or in combination. These and other features of the present invention will be described in more detail below in the detailed description of the invention and in conjunction with the following figures.

### BRIEF DESCRIPTION OF THE DRAWINGS

In order that the present invention may be more clearly ascertained, some embodiments will now be described, by way of example, with reference to the accompanying drawings, in which:

FIG. 1 is perspective view of a conventional stringed instrument;

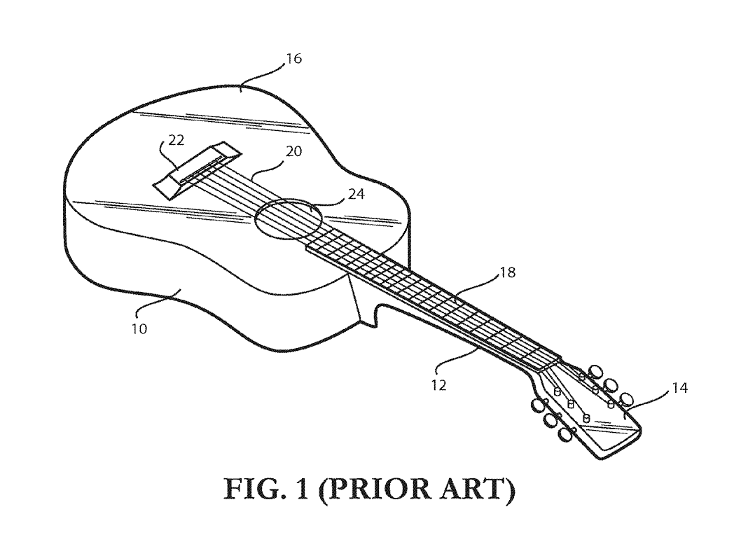

FIG. 2 is a chart showing dampening on the x axis and stiffness on the y axis;

FIG. 3 is an illustration showing the effect of string vibration on the soundboard of one embodiment of the present invention;

FIG. 4 is a cross-sectional view of a cylindrical structure in accordance with some embodiments of this invention;

FIG. 5 is a cross-sectional view of an exemplary soundboard in accordance with some embodiments of this invention;

FIG. 6 is a cross-sectional view of an alternative exemplary soundboard in accordance with other embodiments of this invention;

FIG. 7 is a cross-sectional view of an exemplary string instrument body in accordance with some embodiments of this invention;

FIG. 8 includes cross-sectional views of an exemplary bridge plate in accordance with some embodiments of this invention; and

FIG. 9 includes cross-sectional views of alternative exemplary bracing profiles in accordance with various embodiments of this invention.

### DETAILED DESCRIPTION

The present invention will now be described in detail with reference to several embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well-known process steps and/or structures have not been described in detail in order to not unnecessarily obscure the present invention. The features and advantages of the present invention may be better understood with reference to the drawings and discussions that follow.

Aspects, features and advantages of exemplary embodiments of the present invention will become better understood with regard to the following description in connection with the accompanying drawing(s). It should be apparent to those skilled in the art that the described embodiments of the present invention provided herein are illustrative only and not limiting, having been presented by way of example only. All features disclosed in this description may be replaced by alternative features serving the same or similar purpose, unless expressly stated otherwise. Therefore, numerous other embodiments of the modifications thereof are contemplated as falling within the scope of the present invention as defined herein and equivalents thereto. Hence, use of absolute and/or sequential terms, such as, for example, “will,” “will not,” “shall,” “shall not,” “must,” “must not,” “first,” “initially,” “next,” “subsequently,” “before,” “after,” “lastly,” and “finally,” are not meant to limit the scope of the present invention as the embodiments disclosed herein are merely exemplary.

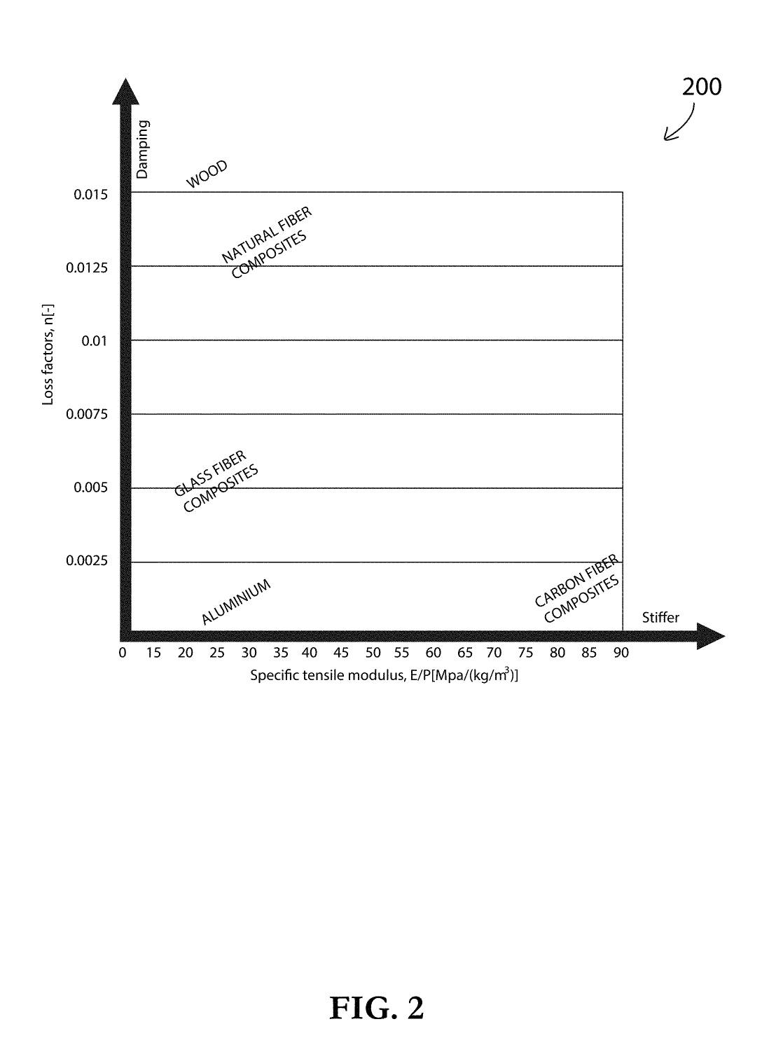

Referring to FIG. 2, this chart illustrates notably, the high dampening qualities of both wood and natural fiber composites on one dimension and the relatively high tensile modulus of natural fiber composites as compared with wood. Carbon fiber composites have relatively low dampening and exceptionally high tensile modulus. Combined with a core material such as middle layer 530, the thickness becomes too thin to be practical in manufacturing.

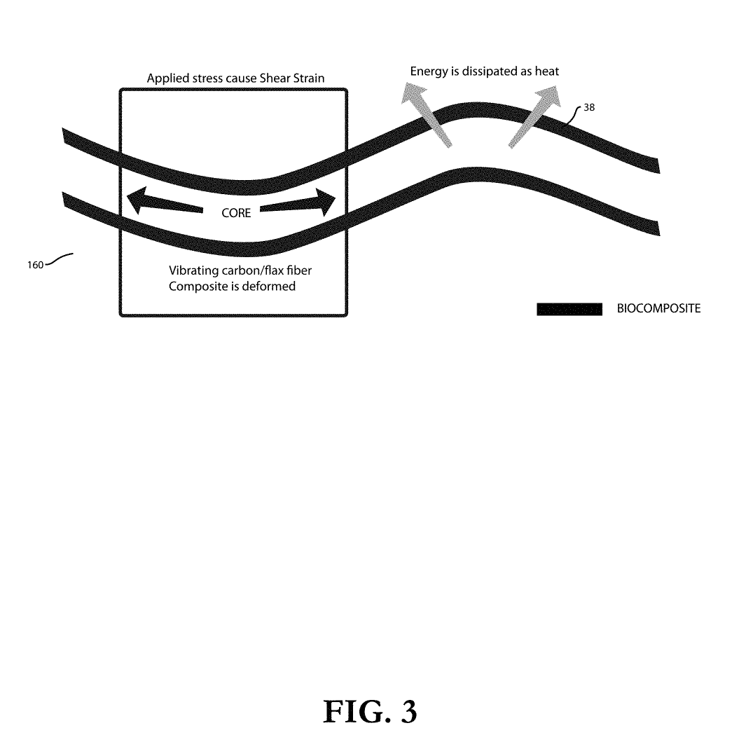

FIG. 3, is a graphical representation of vibration damping and illustrates the effect of string vibration on soundboards of some embodiments of the present invention.

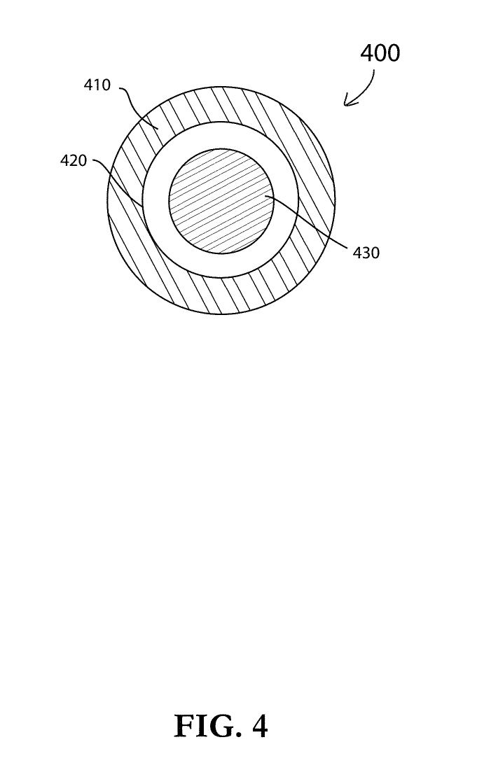

Referring to the cross-sectional view of FIG. 4, in some embodiments, a cylindrical structure such as tube 400 includes top layer 410, middle layer 420, and bottom layer 430. Top layer 410 is made of one or more layers of uni-directional or bi-directional continuous natural fiber such as cotton, flax, cellulose, sisal, ramie, hemp, and Jute, approximately 0.05 mm-0.3 mm approximately 50-250 gsm. Middle layer 420 is made of a core material such as foam, balsa, cork, birch plywood, cardboard, laminate bulker, aluminum and composite honeycomb such as Nomex manufactured by DuPont of Wilmington, Del. These cores can range in thickness from approximately 2-10 mm. Tube 400 is useful for construction the soundboard of string instruments such as guitars, ukuleles, and violins. Bottom layer 430 is made of a least one layer of uni-directional and/or bi-directional bast-based fiber such as flax, hemp, and Jute, approximately 0.1 mm-0.5 mm approximately 50-250 gsm. Tube 400 can also be used to construct the shells of acoustic instruments such as drums. Other suitable natural fiber materials include recycled paper products, recycled wood products, and other suitable bio materials known to one skilled in the art.

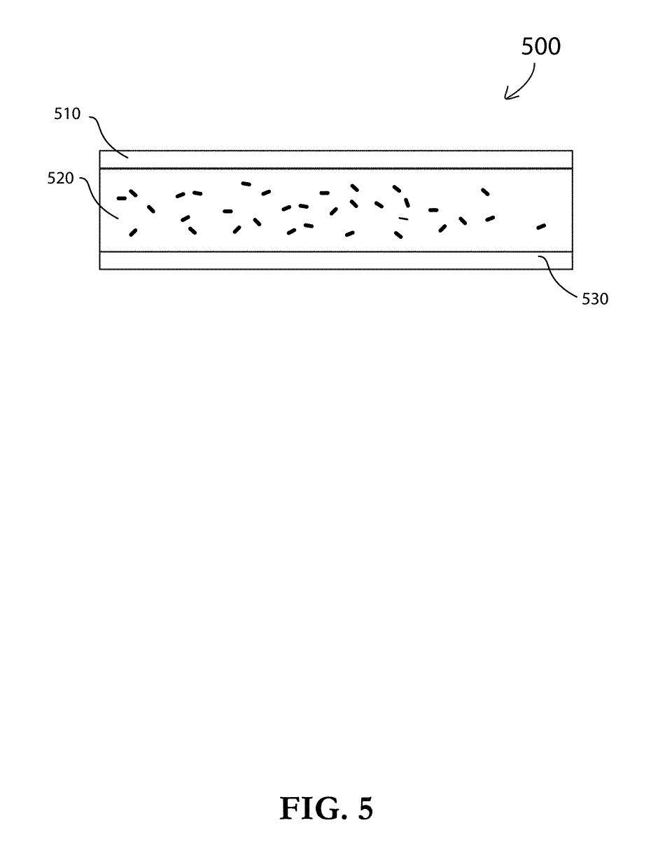

Referring to the cross-sectional view of FIG. 5, an exemplary embodiment of a soundboard includes a sandwich 500 includes top layer 510, middle layer 520, and bottom layer 530. Top layer 510 is made of one or more layers of uni-directional or bi-directional continuous natural fiber such as flax, cellulose, sisal, ramie, hemp, and Jute, approximately 0.05 mm-0.3 mm approximately 50-250 gsm. Middle layer 520 is made of a core material such as foam, balsa, cork, birch plywood, aluminum and composite honeycomb in a range of thickness approximately 1.5 mm-5 mm. Sandwich 500 is useful for construction the soundboard of string instruments such as guitars, ukuleles, and violins. Bottom layer 530 is made of a least one layer of uni-directional and/or bi-directional bast-based fiber such as flax, hemp, kenaf, sisal, ramie and Jute, approximately 0.1 mm-0.5 mm approximately 50-250 gsm. Sandwich 500 can also be used to construct the shells of acoustic instruments such as drums. In some embodiments, top layer 510 includes two uni-directional layers each about 50-250 gsm in thickness.

In some embodiments, top layer and bottom layer 510 and 530 can be made of preimpregnated composite with suitable adhesive such as epoxy, bio-based epoxy, polyester, vinylester, hemicellulose, sap, sugar resin and phenolic and/or any other natural and/or synthetic compounds known.

In another embodiment, top layer and bottom layer 510 and 530 can be made using suitable liquid adhesive applied directly to the dry fabric by brush injection and/or vacuum infused.

In yet another embodiment, top layer and bottom layer 510 and 530 can be made using a sheet molding compound and/or film adhesive applied directly to the dry fabric. It is also possible for a top layer 510 to be prepreg and a bottom layer 530 to be a dry fabric layer with suitable adhesive.

Top layer and bottom layer 510 and 530 can be adhered with the middle layer(s) 520 under compression at approximately 10-100 psi using for example a vacuum, compression press, autoclave and/or continuous lamination as well processing at a temperature range of approximately 70-250 degrees Fahrenheit (“F”).

Middle core layer 520, as is known to people familiar in the art of composites, adds exponential specific tensile modulus proportional to thickness.

### Smaller Instruments and/or Lower String Tension

In some smaller instruments such as ukuleles and classical guitars with lower tension nylon strings, thinner middle layer 520 may be used with a range in thickness of approximately 1 mm-2 mm and top layer and bottom layer 510 and 530 with a range of thickness from approximately 0.05 mm-0.2 mm.

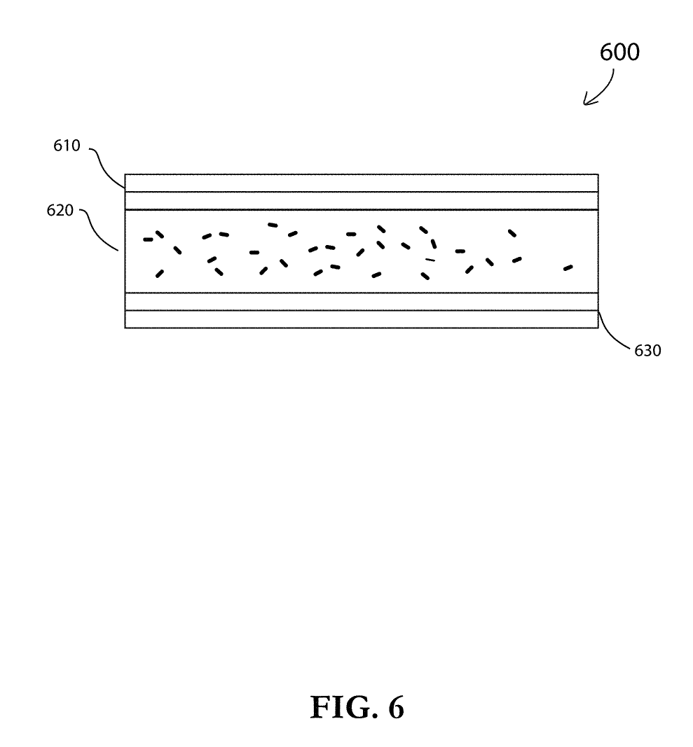

Referring to the cross-sectional view FIG. 6, in yet another embodiment of the invention, a soundboard includes a sandwich 600 includes top layer 610, middle layer 620, and bottom layer 630. Top layer 610 is made of one or more layers of uni-directional, bi-directional, and/or discontinuous and/or continuous natural fiber such as flax, cellulose, sisal, ramie, hemp, and Jute, approximately 0.05 mm-0 .3 mm approximately 50-250 gsm laminated with one or more layers of uni-directional and/or bi-directional aramid, Innegra, carbon fiber, or fiberglass, approximately 0.05 mm-0.3 mm approximately 50-250 gsm. Middle layer 620 is made of a core material such as foam, balsa, cork, birch plywood, aluminum and composite honeycomb in a range of thickness approximately 1 mm-7 mm. Sandwich 600 is useful for construction the soundboard of musical instruments such as guitars, ukuleles, pianos and violins. Bottom layer 630 is made of one layer of uni-directional and/or bi-directional bast-based fiber such as flax, hemp, and Jute, approximately 0.1 mm-0.5 mm approximately 50-250 gsm and one or more layers of uni-directional and/or bi-directional aramid, Innegra, carbon fiber, or fiberglass, approximately 0.05 mm-0.3 mm approximately 50-250 gsm. Sandwich 600 can also be used to construct the shells of acoustic instruments such as drums.

In some embodiments, the soundboard includes a hybrid weave with natural fibers and carbon fiber woven at about 0-90 degrees to each other. It is also possible for the hybrid weave to include natural fibers and/or synthetic fibers arranged in substantially randomized directions.

In some embodiments, top layer and bottom layer 610 and 630 can be made of preimpregnated composite with suitable adhesive such as epoxy, bio-based epoxy, polyester, vinylester, hemicellulose, sugar resin and phenolic.

In other embodiments, top layer and bottom layer 610 and 630 can be made using suitable liquid adhesive applied directly to the dry fabric by brush injection and/or vacuum infused.

In yet another embodiment, top layer and bottom layer 610 and 630 can be made using a sheet molding compound and/or film adhesive applied directly to the dry fabric. It is also possible for a top layer 610 to be prepreg and a bottom layer 630 to be a dry fabric layer with suitable adhesive.

Top layer and bottom layer 610 and 630 can be adhered with the middle layer(s) 620 under compression at approximately 10-100 psi using for example a vacuum, compression press, autoclave and/or continuous lamination as well processing at a temperature range of approximately 70-250 F.

Middle core layer 620, as is known to people familiar in the art of composites, adds exponential specific tensile modulus proportional to thickness.

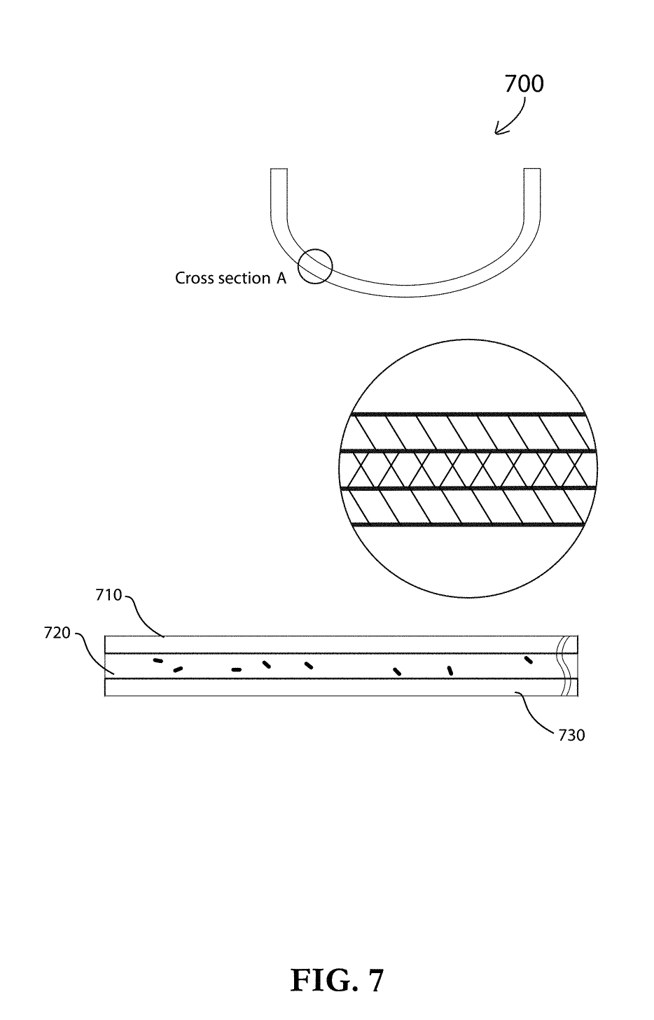

Referring to FIG. 7 which includes cross-sectional views of an exemplary string instrument of the present invention, cross section of body 700 includes top layer 710, middle layer 720, and bottom layer 730. Top layer 710 is of one or more layers of uni-directional or bi-directional bast-based fiber such as such as flax, cellulose, sisal, ramie, hemp, and Jute, approximately 0.05 mm-0.3 mm approximately 50-250 gsm. Middle layer 720 is made of a core material such as foam, cork, balsa, honeycomb in a range of thickness approximately 0.3 mm-7 mm. Middle layer 720 can also be made of one of more layers of biocomposite Cross-section of body 700 is useful for construction of the body of string instruments such as guitars, ukuleles, and violins. Bottom layer 730 is made of a least one layer of uni-directional or bi-directional bast-based fiber such as flax, hemp, and Jute, approximately 0.3 mm-2 mm approximately 50-250 gsm.

In some embodiments, top layer and bottom layer 710 and 730 can be made of pre-impregnated composite with suitable adhesive such as epoxy, bio-based epoxy, polyester, vinylester, hemicellulose, sugar resin and phenolic.

In another embodiment, top layer and bottom layer 710 and 730 can be made of liquid resin applied directly to the dry fabric brush injected or infused.

It is also possible for a top layer 710 to be prepreg and a bottom layer 730 to be a dry fabric layer with suitable adhesive.

Top layer and bottom layer 710 and 730 are combined with middle layer(s) 720 under compression at approximately 10-100 psi using for example a vacuum, compression press, and/or continuous lamination as well processing at a temperature range of approximately 70-250 f.

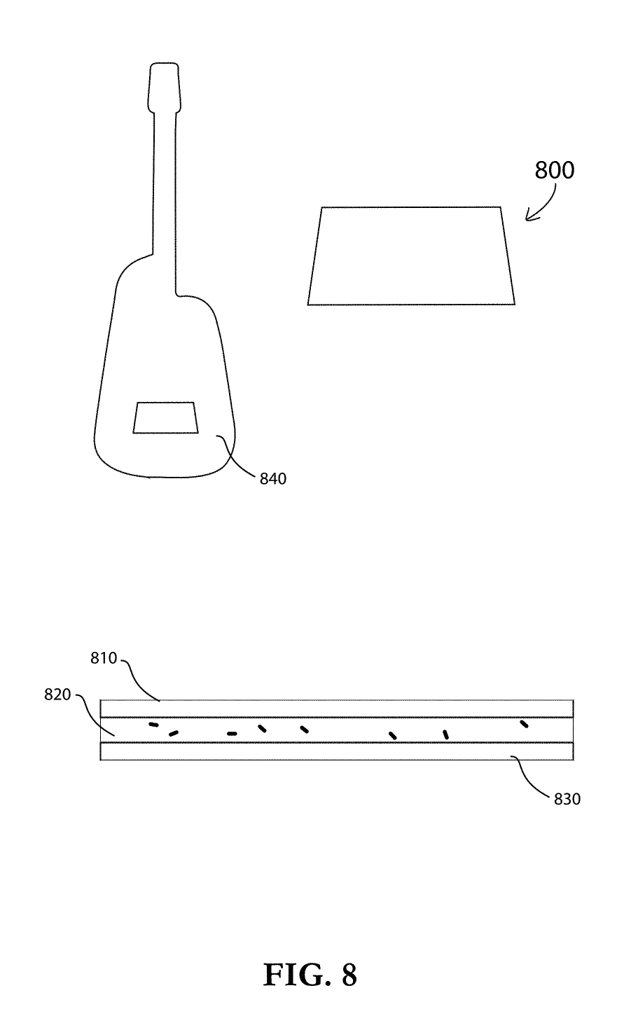

Referring now to FIG. 8, which includes cross-sectional views of an exemplary bridge plate in accordance with some embodiments of this invention, the bridge plate includes the top layer 810 and bottom layer 830 are comprised one or more layers of unidirectional and/or bi-directional bio-based approximately 40-300 gsm fabric. Wherein middle layer 820 is comprised of core material from approximately 1-10 mm thick.

In another embodiment, the top and bottom layers are comprised one or more layers of uni-directional and/or bi-directional aramid and one or more layers of uni-directional and/or bi-directional bio-based fabric.

Similarly, another embodiment, the top and bottom layers are comprised one or more layers of uni-directional and/or bi-directional carbon fiber and one or more layers of uni-directional and/or bi-directional bio-based fabric.

The bridge plate 800 can be mounted to the underside of the soundboard 840 where the strings are mounted via the bridge.

This arrangement adds stiffness to the structure proportional to the geometry and thickness of the bridge plate.

The density of the bridge plate has impact on the timber and warmth of the acoustic tone. Biocomposite enables very low mass bridge plates and thus warm eq.

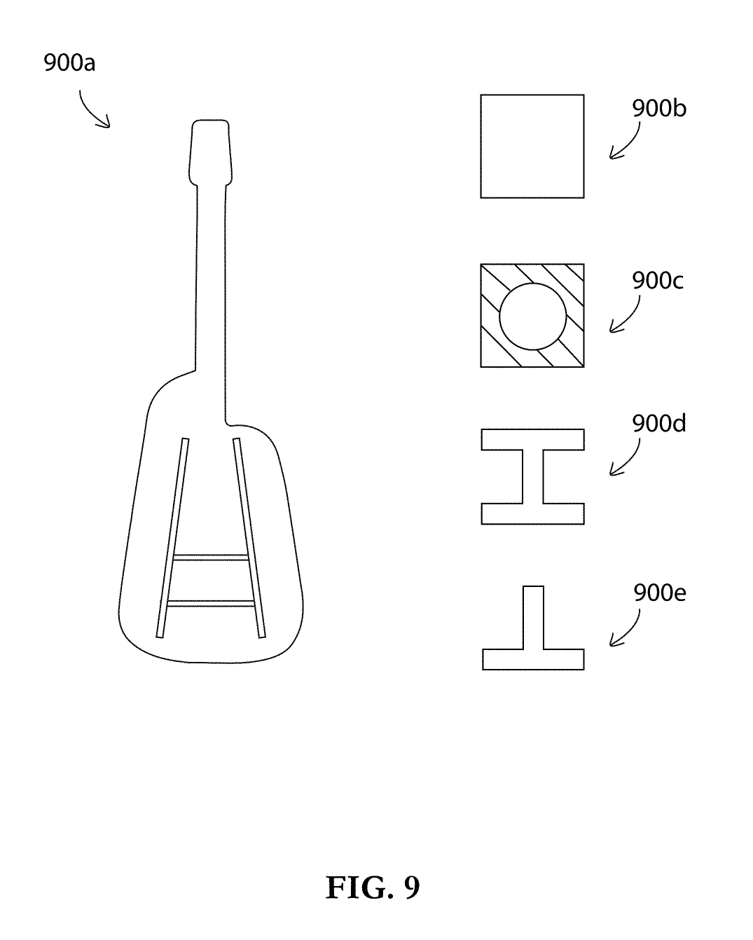

FIG. 9 includes cross-sectional views of alternative exemplary bracing profiles for additional embodiments of the present invention. Referring to bracing assembly 900a, two longitudinally oriented biocomposite tubes and/or rods and/or molded and/or tube/rod subassemblies running the length of the sound box and/or entire length of body including the neck and head. Also shown, are two tubes and/or rods and/or molded components and/or tube/rod subassemblies latitudinal oriented. In other embodiments bracing assembly 900a utilizes a single to a multitude of biocomposite tubes and/or rods and/or molded bracing components and/or tube/rod subassemblies.

Bracing profile cross section 900b, can be a rod made of one or more layers of biocomposite approximately 100 gsm-500 gsm and ranging in size from approximately 2-10 mm square. In another embodiment the rod is rectangular wherein length is approximately 2 mm-8 mm and width approximately 3-12 mm. Other bracing profiles would also effective including Trianglar, T-bracket, L-bracket, half-moon, elliptical, polygonal, or any other suitable profile designs known to one skilled in the mechanical arts. In addition, these bracing profiles may be perforated to further increase their strength to weight ratio. Perforations may be molded, punched, drilled, laser-cut, or otherwise created using methods known to one skilled in the art.

Bracing profile cross section 900c, is a tube made of one or more layers of biocomposite approximately 100 gsm-500 gsm and ranging in size from approximately 2-10 mm square. In another embodiment the tube is rectangular wherein length is approximately 2 mm-8 mm and width approximately 3-12 mm.

Bracing profile cross section 900d, is a I-beam made of one or more layers of biocomposite approximately 100 gsm-500 gsm and ranging in size from approximately 2-12 mm.

Bracing profile cross section 900e, is a tube made of one or more layers of biocomposite approximately 100 gsm-500 gsm and ranging in size from approximately 2-10 mm square. In another embodiment the tube is rectangular wherein length is approximately 2 mm-8 mm and width approximately 3-12 mm.

In some embodiments, cross sections 900a-900e may be tapered wherein the outer edges are substantially thinner than the center. The taper distance ranges from approximately 0-50 mm.

There are various methods to manufacture these tubes, rods and assemblies including compression molding, wrap-rolling, bladder-molding, filament winding and pultrusion. In other embodiments the bracing can be molded as a substantially hollow 3D form. For example an x-brace for a steel string acoustic guitar- thereby eliminating joints, reducing weight and production complexity.

Bracing profiles as shown in 900b-900c and as oriented in assembly 900a, can add substantial stiffness to the structure depending on geometry and thickness.

In some embodiments, the density of each composite skin layer is reduced in order to match or supersede the desired mechanical properties of choice spruce-by using unidirectional natural composites ranging from 5 oz/sq/ft-1.5 oz/sq/ft weight versus 5.9 oz/sq/ft carbon fiber. This 44% lower density skins are bonded to a higher surface area core using approximately 5 oz/sq/ft-1.5 oz/sq/ft of resin without the addition of additional film adhesive. This reduction in resin usage is achieved by a relatively high resin-to-fiber ratio of the pre-impregnated epoxy in the fiber. The extra resin helps bond the fiber to the core by maximizing bonding area.

An example of a suitable pre-impregnated natural composite is manufactured by Lingrove under the brand name Ekoa. A core with higher surface area is also used to help bond the composite skins to the core. One preferred core is made of acrylic foam, manufactured by Evonik under the brand name Rohacell, which has more surface area for bonding than honeycomb. Another is low-density, high surface area core option is end-grain balsa such as made by Baltec. These cores are selected because they can resist the heat and pressure of the molding process, which in combination can help achieve strong interstitial adhesion. The laminating process can be accomplished using compression molding, autoclave, vacuum-bagging, bladder molding to name a few exemplary composite processes.

In some embodiments, carbon fiber bracing and bridge plate are used to reinforce the soundboard made using Ekoa. The resulting composite sound board is tonally superior. High load areas can be reinforced with carbon fiber including the neck, neck-to-body junction, bracing and bridge plate. Reinforcement is preferred because natural fibers such as wood are low density and therefore prone to absorbing moisture. Further natural fibers are visco-elastic causing positive vibration damping qualities for sound quality but negative creep when subject to extreme changes in humidity.

Although Nomex has been promoted as the ideal core material because of its lower density, intended to offset the higher density of the typical carbon fiber skins. Unfortunately, the result is not pleasing tonally due in part to the ultra-low density of the Nomex core which is too vibration-damping. In addition, the relative low surface area of the honeycomb requires an adhesive layer which adds considerable density.

In contrast, the use of foam or balsa as a core results in a tonally superior soundboard when compared with a synthetic soundboard made with a nomex/aramid honeycomb core. Relatively higher density foam and balsa cores offer both reduced vibration damping and substantially increased surface area removing the need for an adhesive layer when composited with linen.

Unidirectional linen fiber can be used for lower tension instruments such as nylon-stringed ukuleles. In order to achieve the aesthetic and look of koa wood which is commonly used for ukuleles, a multidirectional mix of unidirectional linen fiber can be used. For example, a bidirectional mix can include 50-100 gsm of unidirectional fiber oriented in the same direction as the strings, and 50-110 gsm of unidirectional natural fiber oriented perpendicular to the strings.

Unidirectional linen fiber can also be used for higher tension instruments such as acoustic steel-stringed guitars. However, to attain the ideal combination of soundboard stiffness-to-weight and thickness for use in higher tension acoustic guitars, most of fibers are preferably oriented in one-direction parallel to the strings thereby counter-acting string tension. This is similar to the grain found in natural soft wood which coincidentally runs in one-direction. This also has the benefit of matching the aesthetic of natural wood. This is more efficient than using woven fibers of the same weight due to a higher specific modulus.

### Additional Embodiments and Applications

While the above described structures and methods have been exemplified using the construction of stringed musical instruments, many of these structures and methods can be also used for the manufacture of other acoustical musical instruments such as drums. In addition, these structures and methods can also be adapted for manufacturing of other products such as furniture, hand tools, kitchen utensils and storage containers.

For example, with respect to furniture, pieces can be made using the materials and methods described above including: surfaces such as tables, seating, space divider panels, lighting, and built-in interior and exterior architecture. The translucency of the material as well as the ability to mold in three-dimensional forms, makes this particularly useful above and beyond the wood-esque aesthetic. The high stiffness-to-weight substantially improves furniture performance.

Light and stiff panels, either entirely planar or rendered into three-dimensional shapes and made as described above, also have applications in the various sports and leisure applications including, surf boards, snow boards, skate boards, wake boards, skis, scooters, kit boards, stand-up paddle boards and the like. These applications tend to favor high stiffness-to-weight ratios. Other suitable sporting/leisure equipment applications include rackets, paddles, fishing rods, hiking/ski poles, bicycles, trikes, which can also benefit from use of above described methods for manufacturing superior high stiffness-to-weight panels.

Many other applications are also possible. For example, various transportation and/or vehicular applications include automobiles, trains, aircraft, hovercraft, and/or boats/ships. Interior/exterior parts such as dashboards, floor panels, door panels, seat backs, body panels can all benefit from stiff and light panels which can be manufactured using the methods described above.

While this invention has been described in terms of several embodiments, there are alterations, modifications, permutations, and substitute equivalents, which fall within the scope of this invention. Although sub-section titles have been provided to aid in the description of the invention, these titles are merely illustrative and are not intended to limit the scope of the present invention.

It should also be noted that there are many alternative ways of implementing the methods and apparatuses of the present invention. It is therefore intended that the following appended claims be interpreted as including all such alterations, modifications, permutations, and substitute equivalents as fall within the true spirit and scope of the present invention.

What is claimed is:

1. A panel comprising:
at least one surface layer including a plurality of only unidirectional filaments made from a natural material and a resin matrix exterior, and wherein the at least one surface layer does not include any woven material; and
a middle core layer.

2. The panel of claim 1 wherein the middle core layer includes a honeycomb core material.

3. The panel of claim 1 wherein the middle core layer includes a foam material.

4. The panel of claim 1 wherein the middle core layer includes a wood veneer material.

5. The panel of claim 1 wherein the middle core layer includes an end-grain balsa core material.

6. Furniture including a panel comprising:
at least one surface layer having a plurality of only unidirectional filaments made from a natural material and a resin matrix exterior, and wherein the at least one surface layer does not include any woven material; and
a middle core layer.

7. The furniture of claim 6 wherein the middle core layer includes a honeycomb core material.

8. The furniture of claim 6 wherein the middle core layer includes a foam material.

9. The furniture of claim 6 wherein the middle core layer includes a wood veneer material.

10. The furniture of claim 6 wherein the middle core layer includes an end-grain balsa core material.

11. A vehicle including a panel comprising:
at least one surface layer having a plurality of only unidirectional filaments made from a natural material and a resin matrix exterior, and wherein the at least one surface layer does not include any woven material; and
a middle core layer.

12. The vehicle of claim 11 wherein the middle core layer includes a honeycomb core material.

13. The vehicle of claim 11 wherein the middle core layer includes a foam material.

14. The vehicle of claim 11 wherein the middle core layer includes a wood veneer material.

15. The vehicle of claim 11 wherein the middle core layer includes an end-grain balsa core material.

16. Sporting equipment including a panel comprising:
at least one surface layer having a plurality of only unidirectional filaments made from a natural material and a resin matrix exterior, and wherein the at least one surface layer does not include any woven material; and
a middle core layer.

17. The sporting equipment of claim 16 wherein the middle core layer includes a honeycomb core material.

18. The sporting equipment of claim 16 wherein the middle core layer includes a foam material.

19. The sporting equipment of claim 16 wherein the middle core layer includes a wood veneer material.

20. The sporting equipment of claim 16 wherein the middle core layer includes an end-grain balsa core material.
